(19) United States
(12) Patent Application Publication
(10) Pub. No.: US 2024/0393595 A1
(43) Pub. Date: Nov. 28, 2024

(54) OBSERVATION OPTICAL SYSTEM AND IMAGE DISPLAY APPARATUS USING OBSERVATION OPTICAL SYSTEM

(71) Applicant: CANON KABUSHIKI KAISHA, Tokyo (JP)

(72) Inventor: KAZUTAKA INOGUCHI, Tokyo (JP)

(21) Appl. No.: 18/669,314

(22) Filed: May 20, 2024

(30) Foreign Application Priority Data
May 23, 2023 (JP) 2023-084771

(51) Int. Cl. G02B 27/01; G02B 5/30

(52) U.S. Cl. CPC G02B 27/0172; G02B 5/3083; G02B 2027/0178

(57) ABSTRACT

An observation optical system configured to guide light from a display device configured to display an image to an observer includes a lens having a display-side surface and an observation-side surface with different curvature radii, and includes a first semi-transmissive reflective surface, a first λ/4 plate, a second semi-transmissive reflective surface, a second λ/4 plate, and a polarization plate, which are sequentially arranged from a display side to an observation side, and wherein, when, out of the first semi-transmissive reflective surface and the second semi-transmissive reflective surface, a reflection surface having a smaller absolute value of a focal length is a reflection surface A, a focal length of the reflection surface A is fA, and an air conversion distance on an axis from a position of an exit pupil to the reflection surface A is LaA, the following inequality is satisfied: 1.0<LaA/|fA|<3.0.

### BACKGROUND

### Technical Field

The aspect of the embodiments relates to an observation optical system and an image display apparatus using the observation optical system, and is suitable for a wearable image display apparatus such as a head mounted display (HMD).

### Description of the Related Art

An observation optical system used in an image display apparatus such as an HMD has been requested to be downsized while having a wide view angle.

Japanese Patent Application Laid-Open No. 2005-148655 discloses a configuration utilizing polarization to fold an optical path.

One configuration of Japanese Patent Application Laid-Open No. 2005-148655 includes a polarization beam splitter and a half mirror that are sequentially arranged from an observation side to a display side to fold the optical path by utilizing polarization. As a result, outside light incident from the observation side on an observation optical system is reflected by the half mirror, reflected by the polarization beam splitter, further reflected by the half mirror, and thereafter incident on eyes of an observer as ghost light that has passed through the polarization beam splitter.

Another configuration of Japanese Patent Application Laid-Open No. 2005-148655 includes the half mirror and the polarization beam splitter that are sequentially arranged from the observation side to the display side to fold the optical path by utilizing polarization. However, because the polarization beam splitter has a planar shape, outside light that is incident from the observation side on the observation optical system passes through the half mirror, is reflected by the polarization beam splitter, passes through the half mirror, and is incident on the eyes of the observer as ghost light.

In the configuration, the half mirror that plays a role as main power of image formation is a concave mirror on the display side, and tends to have a larger diameter.

### SUMMARY

According to an aspect of the embodiments, an observation optical system is configured to guide light from a display device configured to display an image to an observer, and the observation optical system includes a lens having a display-side surface and an observation-side surface with different curvature radii, and includes a first semi-transmissive reflective surface, a first λ/4 plate, a second semi-transmissive reflective surface, a second λ/4 plate, and a polarization plate, wherein the first semi-transmissive reflective surface, the first λ/4 plate, the second semi-transmissive reflective surface, the second λ/4 plate, and the polarization plate are sequentially arranged from a display side to an observation side, and wherein, when, out of the first semi-transmissive reflective surface and the second semi-transmissive reflective surface, a reflection surface having a smaller absolute value of a focal length is a reflection surface A, a focal length of the reflection surface A is fA, and an air conversion distance on an axis from a position of an exit pupil to the reflection surface A is LaA, the following inequality is satisfied: 1.0<LaA/|fA|<3.0.

Further features of the disclosure will become apparent from the following description of exemplary embodiments with reference to the attached drawings.

### BRIEF DESCRIPTION OF THE DRAWINGS

FIG. 1 is a configuration diagram illustrating a main section in a first exemplary embodiment.

FIG. 2 is a configuration diagram illustrating a main section in a second exemplary embodiment.

FIGS. 3A and 3B are diagrams each illustrating an optical path of polarized light in the first exemplary embodiment.

FIGS. 4A and 4B are diagrams each illustrating an optical path of polarized light in the second exemplary embodiment.

FIGS. 5A and 5B are diagrams each illustrating an optical path of polarized light in a third exemplary embodiment.

FIG. 6 is a diagram illustrating an optical path of polarized light in a fourth exemplary embodiment.

FIG. 7 is a diagram illustrating a state where outside light is incident on an observation optical system.

FIGS. 8A to 8C are diagrams each illustrating a state where ghost light is generated.

FIG. 9 is a diagram illustrating a configuration in which a light shielding member is arranged.

FIG. 10 is an optical path diagram in Numerical Example 1.

FIG. 11 is an optical path diagram in Numerical Example 2.

FIG. 12 is an optical path diagram in Numerical Example 3.

FIG. 13 is an optical path diagram in Numerical Example 4.

FIG. 14 is an optical path diagram in Numerical Example 5.

FIG. 15 is a view illustrating a head mounted display (HMD) using the observation optical system according to any of the first to fourth exemplary embodiments.

### DESCRIPTION OF THE EMBODIMENTS

Exemplary embodiments of the present invention will be described with reference to the drawings.

In description of each exemplary embodiment of the present invention, a state represented by a concept such as linear polarization, circular polarization, and a λ/4 phase difference, which represent light polarization states, means a broad state having a certain range. Thus, an error in the state does not hinder the intrinsic effect of the present invention. A phase difference that is generated in each optical device is a phase difference regarding light with a wavelength λ. The wavelength λ can be freely selected from wavelengths in a visible light range, and is, for example, λ=580 nm, but is not limited to the example.

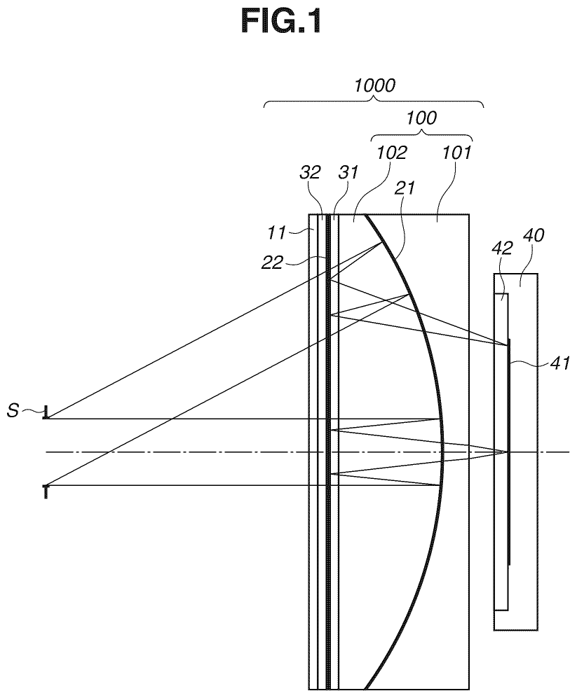

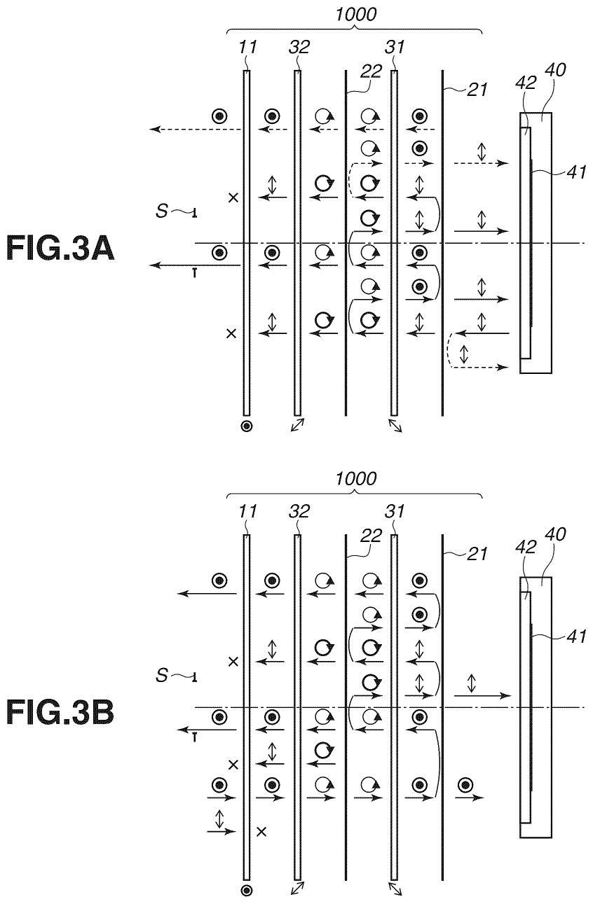

A first exemplary embodiment is now described with reference to FIG. 1 and FIGS. 3A and 3B. FIG. 1 is a configuration diagram of a main section in the first exemplary embodiment, and illustrates an observation optical system 1000. The observation optical system 1000 includes a lens element 100 composed of a plano-concave lens 101 and a plano-convex lens 102. A display device 40 is, for example, a liquid crystal panel or an organic electroluminescent (EL) panel. The display device 40 includes an optical flat plate portion 42 including a display surface 41 and a cover glass plate.

The optical flat plate portion 42 includes a linear polarization plate. Light from an image displayed on the display surface 41 becomes predetermined linearly polarized light via the optical flat plate portion 42, and is guided toward an exit pupil S via the observation optical system 1000. A position of the exit pupil S represents a position of an intersection point between a central ray of a light flux guided from a maximum product height on the display surface 41 to the exit pupil S and an optical axis.

To fold an optical path, the observation optical system 1000 includes a first semi-transmissive reflective surface 21, a first λ/4 plate 31, a second semi-transmissive reflective surface 22, a second λ/4 plate 32, and a linear polarization plate 11, which are sequentially arranged from the display device 40 side to the exit pupil S side. Each of the first semi-transmissive reflective surface 21 and the second semi-transmissive reflective surface 22 is a half mirror. The half mirror is a device that transmits part of light regardless of polarization and reflects part of light. A ratio between transmission and reflection of light incident on the half mirror may not be 50 to 50, and may be, for example, 30 to 70, or 70 to 30.

Each of the first λ/4 plate 31 and the second λ/4 plate 32 is a waveplate that gives a λ/4 phase difference to two polarization components that are orthogonal to each other. The linear polarization plate 11 is a polarization plate that transmits predetermined linearly polarized light and that absorbs linearly polarized light orthogonal to the predetermined linearly polarized light.

The first semi-transmissive reflective surface 21 is formed between the plano-concave lens 101 and the plano-convex lens 102. The second semi-transmissive reflective surface 22 is formed between the first λ/4 plate 31 and the second λ/4 plate 32. With this configuration, it is possible to appropriately adjust a polarization direction of light emitted from the display device 40 and fold the optical path. The reason for this is now described with reference to FIG. 3A.

FIG. 3A illustrates an optical path of polarized light in the observation optical system 1000. The display device 40 is a liquid crystal display device that emits first linearly polarized light vibrating in a direction parallel to a paper surface. The lower portion of FIG. 3A illustrates respective inclinations of slow axes of the first λ/4 plate 31 and the second λ/4 plate 32 when viewed from the exit pupil S side. The slow axes are arranged at inclinations of +45 and −45 with respect to a vibration direction of the first linearly polarized light.

The first λ/4 plate 31 and the second λ/4 plate 32 are arranged in such a direction as that respective slow axes thereof are orthogonal to each other. Regarding the linear polarization plate 11, the lower portion of FIG. 3A illustrates a direction of an axis in which light passes through the linear polarization plate 11. The linear polarization plate 11 is configured to transmit light vibrating in a direction orthogonal to the first linear polarized light.

In FIG. 3A, light emitted from the display surface 41 of the display device 40 passes through the optical flat plate portion 42 to become linear polarized light vibrating in the direction parallel to the paper surface, and becomes circularly polarized light in a clockwise direction at the first λ/4 plate 31. The light that has become the circularly polarized light in the clockwise direction is reflected by the second semi-transmissive reflective surface 22, becomes linearly polarized light vibrating in a direction perpendicular to the paper at the first λ/4 plate 31, and is reflected by the first semi-transmissive reflective surface 21 to become circularly polarized light in a counterclockwise direction at the first λ/4 plate 31.

The light that has become the circularly polarized light in the counterclockwise direction becomes linear polarized light vibrating in the direction perpendicular to the paper at the second λ/4 plate 32, passes through the linear polarization plate 11, and is guided to the exit pupil S. The observation optical system 1000 has a configuration in which each of reflected light and transmitted light is generated on the first semi-transmissive reflective surface 21 and the second semi-transmissive reflective surface 22, but unnecessary light of either of the reflected light and the transmitted light is blocked by the linear polarization plate 11 or the like and not guided to the exit pupil S or passes through the first semi-transmissive reflective surface 21 and the second semi-transmissive reflective surface 22 multiple times, and is thereby attenuated and becomes less recognizable.

The above-mentioned configuration enables folding of the optical path.

The observation optical system 1000 according to the present invention is configured to satisfy the following inequality:

$$1.0 < LaA / \vert fA \vert < 3. \qquad ( 1 )$$

Assume that when a reflection surface having a smaller absolute value of a focal length out of the first semi-transmissive reflective surface 21 and the second semi-transmissive reflective surface 22 is a reflection surface A, fA represents a focal length of the reflection surface A, and LA represents an air conversion distance on the optical axis from the position of the exit pupil S to the reflection surface A.

The air conversion distance on the optical axis from the position of the exit pupil S to the reflection surface A mentioned herein is a value obtained by division of a thickness of each element that transmits light by a refractive index of each element and addition of result values.

Out of ghost light due to outside light, light reflected by the first semi-transmissive reflective surface 21 twice or more is reduced by the arrangement of a polarizer, and light reflected by the first semi-transmissive reflective surface 21 once is mainly reduced by the inequality (1). The reason for this is now described.

FIG. 3B illustrates an optical path of outside light in the observation optical system 1000. Out of outside light incident from the exit pupil S side on the observation optical system 1000, linear polarized light vibrating in the direction parallel to the paper is absorbed in the linear polarization plate 11, and linearly polarized light vibrating in the direction perpendicular to the paper passes through the linear polarization plate 11. The light that has passed through the linear polarization plate 11 becomes circularly polarized light in the counterclockwise direction at the second λ/4 plate 32 to pass through the second λ/4 plate 32, and becomes linear polarized light vibrating in the direction perpendicular to the paper at the first λ/4 plate 31 to pass through the first λ/4 plate 31. The light that has passed through the first λ/4 plate 31 is reflected by the first semi-transmissive reflective surface 21, and becomes circularly polarized light in the counterclockwise direction at the first λ/4 plate 31.

The light that has become the circularly polarized light in the counterclockwise direction diverges into first ghost light and second ghost light. The first ghost light is circularly polarized light in the counterclockwise direction and passes through the second semi-transmissive reflective surface 22. The second ghost light is circularly polarized light in the clockwise direction and reflected by the second semi-transmissive reflective surface 22. The first ghost light becomes linearly polarized light vibrating in the direction perpendicular to the paper surface at the second λ/4 plate 32 to pass through the second λ/4 plate 32, and is emitted to the exit pupil S side. The second ghost light becomes linearly polarized light vibrating in the direction parallel to the paper surface at the first λ/4 plate 31 to pass through the first λ/4 plate 31, is reflected by the first semi-transmissive reflective surface 21, and becomes circularly polarized light in the clockwise direction at the first λ/4 plate 31.

The light that has become the circularly polarized light in the clockwise direction diverges into third ghost light and fourth ghost light. The third ghost light is circularly polarized light in the clockwise direction and passes through the second semi-transmissive reflective surface 22. The fourth ghost light is circularly polarized light in the counterclockwise direction and is reflected by the second semi-transmissive reflective surface 22. The third ghost light becomes linearly polarized light vibrating in the direction parallel to the paper surface at the second λ/4 plate 32 to pass through the second λ/4 plate 32, and is absorbed in the linear polarization plate 11.

The observation optical system 1000 has a configuration in which the fourth ghost light that is guided to the exit pupil S side is further reflected once more by each of the first semi-transmissive reflective surface 21 and the second semi-transmissive reflective surface 22 in comparison with the third ghost light, so that light intensity becomes lower, and the observer is less likely to visually recognize the ghost light. Ghost light that has been reflected by the first semi-transmissive reflective surface 21 more times than the fourth ghost light is reflected becomes lower in intensity than the fourth ghost light, and is less likely to be visually recognized by the observer.

As described above, out of ghost light caused by outside light, light reflected by the first semi-transmissive reflective surface 21 twice or more is reduced by the arrangement of the polarizer.

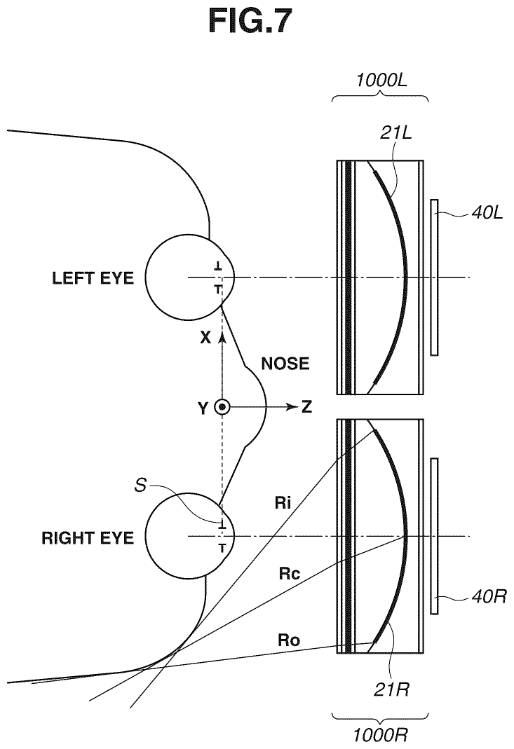

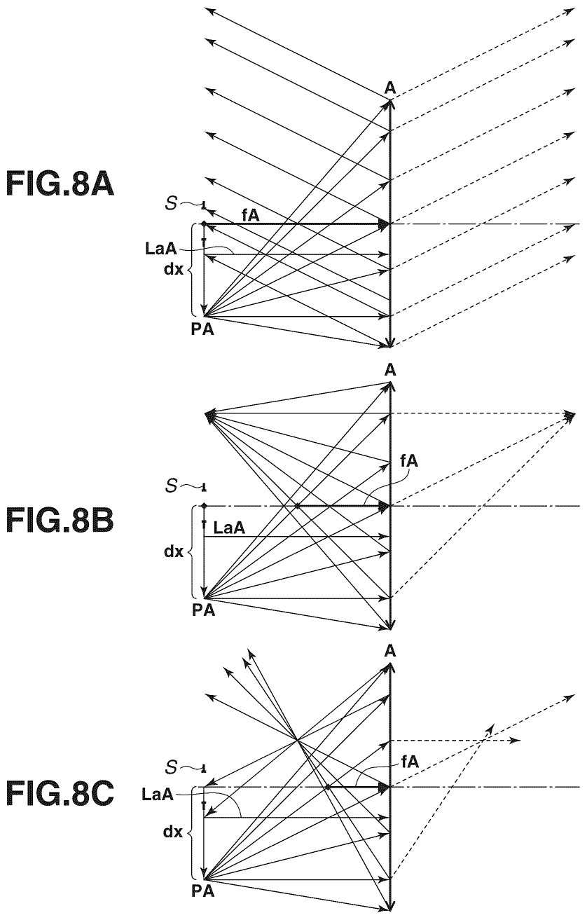

A description will be given of an effect in which appropriately setting a focal length of the first semi-transmissive reflective surface 21 can reduce the first ghost light that is guided to the exit pupil S side, that is, light that is reflected by the first semi-transmissive reflective surface 21 once, with reference to FIG. 7 and FIGS. 8A to 8C. In FIG. 7 and FIGS. 8A to 8C, a Z-axis is defined as an optical-axis direction, an X-axis is defined as a direction that is perpendicular to the optical axis and parallel to the paper surface, and a Y-axis is defined as a direction that is perpendicular to the paper surface.

FIG. 7 is a diagram illustrating a state where outside light incident from the exit pupil S side on a right-eye observation optical system 1000R is incident on a semi-transmissive reflective surface 21R. Light rays Ri, Rc, and Ro as outside light are light rays that pass near the right eye side of the face, and are incident on the innermost side of the semi-transmissive reflective surface 21R, the center of the semi-transmissive reflective surface 21R, and the outermost side of the semi-transmissive reflective surface 21R, respectively. The light rays Ri, Rc, and Ro are condensed so that an intersection point thereof is near a predetermined position in the vicinity of the face. Out of outside light, light that passes near the right eye side of the face and that is reflected by the semi-transmissive reflective surface 21R has a small angle with respect to the optical axis, and is relatively easily guided to the eyes of the observer.

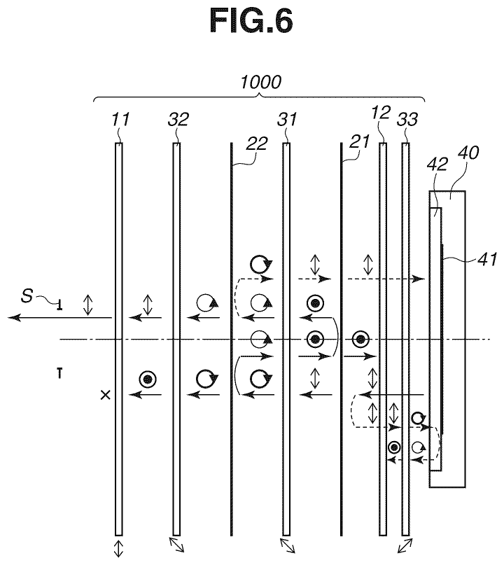

FIGS. 8A to 8C are diagrams each illustrating a state where ghost light is generated. For simple illustration of a state where the light rays Ri, Rc, and Ro illustrated in FIG. 6 are incident on the right-eye observation optical system 1000R and reflected by the semi-transmissive reflective surface 21R, it is assumed that a concave mirror of the semi-transmissive reflective surface 21R is regarded as an ideal lens (reflection surface) A having a planar shape and the light rays Ri, Rc, and Ro intersect with each other at an intersection point PA. That is, FIGS. 8A to 8C each illustrate a state where the intersection point PA is assumed to be an object point of ghost light. Light refracted by the ideal lens A is indicated by broken lines, and light that is reflected by the ideal lens A is indicated by inverted lines of the broken lines with respect to the ideal lens A.

FIG. 8A is a diagram in a case where a distance from the exit pupil S of the observation optical system 1000 to the ideal lens A is fA. That is, FIG. 8A illustrates a case where LaA is equal to |fA|. Assume that the intersection point PA of the light rays Ri, Rc, and Ro is arranged at a position that is away from the center of the exit pupil S by a distance dX in a negative direction with respect to the Z-axis. In a case where LaA and |fA| are equal, light is reflected in parallel to reflected light of a light ray connecting the intersection point PA between the reflection surface A and the optical axis and the center of the exit pupil S.

In a case where a display view angle of the observation optical system 1000 is a wide view angle, that is, in a case where a diameter of the ideal lens A is large, it is not favorable because at least part of ghost light that has been reflected by the reflection surface A once is incident on the exit pupil S. The same applies to a case where |fA| is smaller than LaA.

FIG. 8B illustrates a case where a relation of LaA=2×|fA| is satisfied. Light emitted from the intersection point PA is condensed into a point at a position of dX in a positive direction with respect to the Z-axis, and is not incident on the exit pupil S. That is, it is possible to suppress ghost light.

FIG. 8C illustrates a case where a relation of LaA=3×|fA| is satisfied. Light emitted from the intersection point PA is condensed at a position relatively near the reflection surface A with respect to the exit pupil S in the Z-axis direction. Hence, in a case where the display view angle of the observation optical system 1000 is a wide view angle, that is, in a case where the diameter of the first semi-transmissive reflective surface 21 is large, it is not favorable because at least part of ghost light that has been reflected by the reflection surface A once is incident on the exit pupil S. The same applies to a case where LaA>3×|fA|.

With the above-mentioned configuration, it is possible to obtain the observation optical system 1000 that is advantageous in reduction of ghost light due to outside light while having a wide view angle and a small size.

In one embodiment, at least one of an upper limit or a lower limit of a numeric value range in the inequality (1) is a numeric value defined by the following inequality (1a):

$$1.1 < LaA / \vert fA \vert < 2.5 \qquad ( 1 a )$$

Furthermore, in another embodiment, at least one of the upper limit or the lower limit of the numeric value range in the inequality (1) is in a range defined by the following inequality (1b):

$$1.2 < LaA / \vert fA \vert < 2.3 \qquad ( 1 b )$$

An exemplary configuration of the observation optical system 1000 is now described.

In one embodiment, the reflection surface A is a concave surface that is concave toward the exit pupil S side. With the configuration in which the reflection surface A is the concave surface that is concave toward the exit pupil S side, the reflection surface A has a concentric shape on the exit pupil S side, and various aberrations outside the axis are easily corrected. The configuration is also advantageous in downsizing of a diameter.

In one embodiment, conditions that are satisfied by the observation optical system 1000 are now described.

At least one or more of the following inequalities is satisfied by the observation optical system 1000.

$$0.60 < \vert fA \vert / f < 1.5 \qquad ( 2 )$$

$$0 ° < ω < 45 ° \qquad ( 3 )$$

$$- 6. < R / f < - 1. \qquad ( 4 )$$

In the inequality (4), f represents a focal length of the observation optical system 1000, @ represents an absolute value of an angle of outside light incident on the observation optical system 1000 with respect to the optical axis, and R represents a curvature radius of the reflection surface A.

In a case where the focal length of the reflection surface A exceeds the upper limit of the inequality (2) and is too long, it is not favorable because the optical path length becomes longer. In a case where the focal length of the reflection surface A falls below the lower limit of the inequality (2) and is too short, it is not favorable because various aberrations occurring on the reflection surface A increase.

In a case where the angle of outside light incident on the observation optical system 1000 with respect to the optical axis exceeds the upper limit of the inequality (3) and is too large, it is not favorable because ghost light is likely to be incident on an eye on the opposite side of an eye on which outside light is incident.

In a case where the absolute value of the curvature radius of the reflection surface A exceeds the upper limit of the inequality (4) and is too small, it is not favorable because various aberrations occurring on the reflection surface A increase. In a case where the absolute value of the curvature radius of the reflection surface A falls below the lower limit of the inequality (4) and is too large, it is not favorable because the optical path length becomes too long, and downsizing becomes difficult.

In one embodiment, at least one of the upper limit or the lower limit of the numeric value range in the inequality (2) is a numeric value defined by the following inequality (2a). At least one of the upper limit or the lower limit of the numeric value range in the inequality (3) is a numeric value defined by the following inequality (3a). At least one of the upper limit or the lower limit of the numeric value range in the inequality (4) is a numeric value defined by the following inequality (4a).

$$0.63 < \vert fA \vert / f < 1 \text{.40} \qquad ( 2 a )$$

$$5 ° < ω < 35 ° \qquad ( 3 a )$$

$$- 5. < R / f < - 1.5 \qquad ( 4 a )$$

In another embodiment, at least one of the upper limit or the lower limit of the numeric value range in the inequality (2) is in a range defined by the following inequality (2b). At least one of the upper limit or the lower limit of the numeric value range in the inequality (3) is in a range defined by the following inequality (3b). At least one of the upper limit or the lower limit of the numeric value range in the inequality (4) is in a range defined by the following inequality (4b).

$$0.66 < \vert fA \vert / f < 1 \text{.30} \qquad ( 2 b )$$

$$10 ° < ω < 25 ° \qquad ( 3 b )$$

$$- 4. < R / f < - 2. \qquad ( 4 b )$$

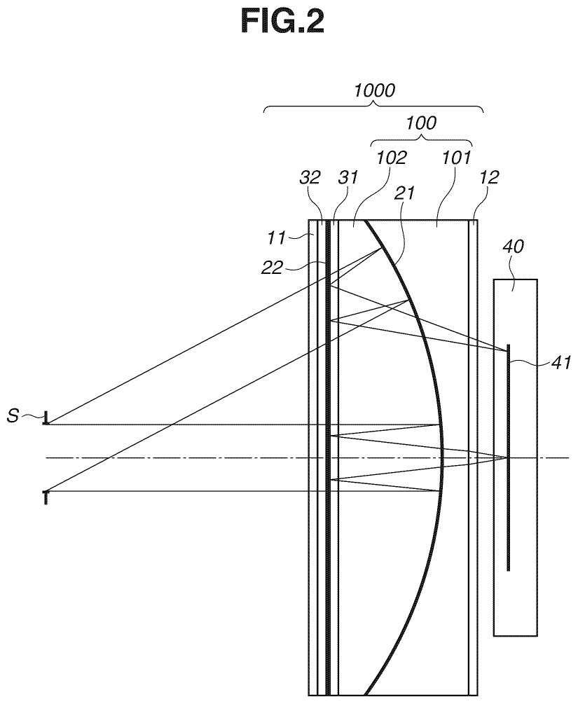

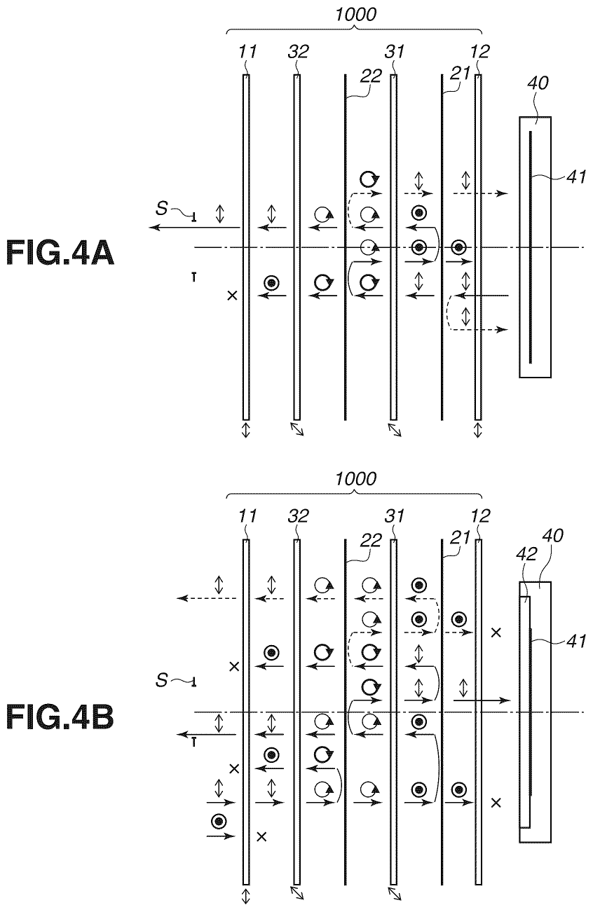

A second exemplary embodiment is now described with reference to FIG. 2 and FIGS. 4A and 4B. Points that are different from the first exemplary embodiment are mainly described. In FIG. 2, the observation optical system 1000 is different from that in the first exemplary embodiment in that a linear polarization plate is not included in the display device 40, and non-polarized light that is not polarized in a specific direction is incident on the observation optical system 1000. Hence, a second linear polarization plate 12 that transmits light vibrating in the direction that is parallel to the paper surface is arranged between the first semi-transmissive reflective surface 21 and the display device 40.

As illustrated in FIG. 4A, the inclination of the slow axis of the second λ/4 plate 32 is +45 when viewed from the exit pupil S side, and the linear polarization plate 11 is configured to transmit light vibrating in a direction parallel to the first linear polarized light. Also with this configuration, it is possible to appropriately change a polarization direction and fold the optical path, similarly to the first exemplary embodiment.

A description will be given of why light reflected by the first semi-transmissive reflective surface 21 twice or more, out of ghost light due to outside light, is reduced by the arrangement of the polarizer according to the second exemplary embodiment.

FIG. 4B illustrates an optical path of outside light in the observation optical system 1000. Out of outside light incident from the exit pupil S side on the observation optical system 1000, linear polarized light vibrating in the direction perpendicular to the paper surface is absorbed in the linear polarization plate 11, and linearly polarized light vibrating in the direction parallel to the paper surface passes through the linear polarization plate 11. The light that has passed through the linear polarization plate 11 becomes circularly polarized light in the counterclockwise direction at the second λ/4 plate 32 to pass through the second λ/4 plate 32, and becomes linear polarized light vibrating in the direction perpendicular to the paper surface at the first λ/4 plate 31 to pass through the first λ/4 plate 31. The light that has passed through the first λ/4 plate 31 is reflected by the first semi-transmissive reflective surface 21, and becomes circularly polarized light in the counterclockwise direction at the first λ/4 plate 31.

The light that has become the circularly polarized light in the counterclockwise direction diverges into first ghost light and second ghost light. The first ghost light is circularly polarized light in the counterclockwise direction and passes through the second semi-transmissive reflective surface 22. The second ghost light is circularly polarized light in the clockwise direction and reflected by the second semi-transmissive reflective surface 22. The second ghost light becomes linearly polarized light vibrating in the direction parallel to the paper surface at the first λ/4 plate 31 to pass through the first λ/4 plate 31, is reflected by the first semi-transmissive reflective surface 21, and becomes circularly polarized light in the clockwise direction at the first λ/4 plate 31.

The light that has become the circularly polarized light in the clockwise direction diverges into third ghost light and fourth ghost light. The third ghost light is circularly polarized light in the clockwise direction and passes through the second semi-transmissive reflective surface 22. The fourth ghost light is circularly polarized light in the counterclockwise direction and is reflected by the second semi-transmissive reflective surface 22. The third ghost light becomes linearly polarized light vibrating in the direction perpendicular to the paper surface at the second λ/4 plate 32 to pass through the second λ/4 plate 32, and is absorbed in the linear polarization plate 11.

The observation optical system 1000 has a configuration in which the fourth ghost light that is guided to the exit pupil S side is further reflected once more by each of the first semi-transmissive reflective surface 21 and the second semi-transmissive reflective surface 22 in comparison with the third ghost light, so that light intensity becomes lower, and the observer is less likely to visually recognize the ghost light. Ghost light that has been reflected by the first semi-transmissive reflective surface 21 more times than the fourth ghost light is reflected becomes lower in intensity than the fourth ghost light, and is less likely to be visually recognized by the observer.

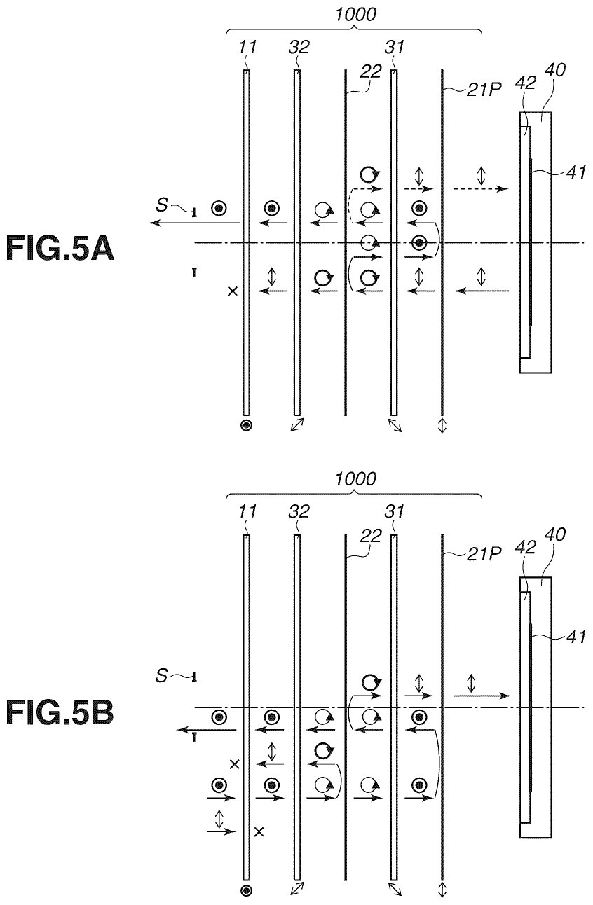

A third exemplary embodiment is now described with reference to FIGS. 5A and 5B. Points that are different from the first exemplary embodiment are mainly described. A first semi-transmissive reflective surface 21P serves as a polarization beam splitter that transmits light vibrating in the direction parallel to the paper and that reflects light vibrating in the direction perpendicular to the paper surface. The polarization beam splitter is a device that transmits the first linearly polarized light and that reflects the second linearly polarized light whose polarization direction is orthogonal to the first linearly polarized light.

By replacing the half mirror in the configuration of the first exemplary embodiment by the polarization beam splitter, it is possible to reduce optical paths of light that is reflected by the polarization beam splitter like optical paths illustrated in FIG. 5A. As a result, the observation optical system 1000 has a configuration in which unnecessary light is less likely to be guided to the exit pupil S side.

Out of ghost light due to outside light, light that reaches the first semi-transmissive reflective surface 21P is reduced by the arrangement of the polarizer according to the third exemplary embodiment. The reason for this is now described.

FIG. 5B illustrates an optical path of outside light in the observation optical system 1000. Out of outside light incident from the exit pupil S side on the observation optical system 1000, linear polarized light vibrating in the direction parallel to the paper is absorbed in the linear polarization plate 11, and linearly polarized light vibrating in the direction perpendicular to the paper passes through the linear polarization plate 11. The light that has passed through the linear polarization plate 11 becomes circularly polarized light in the counterclockwise direction at the second λ/4 plate 32 to pass through the second λ/4 plate 32, and becomes linear polarized light vibrating in the direction perpendicular to the paper surface at the first λ/4 plate 31 to pass through the first λ/4 plate 31. The light that has passed through the first λ/4 plate 31 is reflected by the first semi-transmissive reflective surface 21P, and becomes circularly polarized light in the counterclockwise direction at the first λ/4 plate 31.

The light that has become the circularly polarized light in the counterclockwise direction diverges into first ghost light and second ghost light. The first ghost light is circularly polarized light in the counterclockwise direction and passes through the second semi-transmissive reflective surface 22. The second ghost light is circularly polarized light in the clockwise direction and reflected by the second semi-transmissive reflective surface 22. The second ghost light becomes linearly polarized light vibrating in the direction parallel to the paper at the first λ/4 plate 31 to pass through the first λ/4 plate 31, and passes through the first semi-transmissive reflective surface 21. As a result, it is possible to suppress light that is reflected by the first semi-transmissive reflective surface 21P twice or more and reduce ghost light.

A fourth exemplary embodiment is now described with reference to FIG. 6. Points that are different from the first exemplary embodiment are mainly described. The fourth exemplary embodiment is different from the first exemplary embodiment in that it is directed to further suppression of ghost light that is reflected by the display device 40. Hence, the second linear polarization plate 12 that transmits light vibrating in the direction that is parallel to the paper surface and a third λ/4 plate 33 whose slow axis is inclined by −45 with respect to a vibration direction of the first linearly polarized light are arranged, sequentially from the exit pupil S side, between the first semi-transmissive reflective surface 21 and the display device 40.

As a result, out of light emitted from the display device 40, light reflected by the first semi-transmissive reflective surface 21 passes through the third λ/4 plate 33 to become circularly polarized light in the clockwise direction, and is reflected by the display device 40 to become circularly polarized light in the counterclockwise direction. The light that has become the circularly polarized light in the counterclockwise direction passes through the third λ/4 plate 33 to become linear polarized light vibrating in the direction perpendicular to the paper surface, and is thereby suppressed by the second linear polarization plate 12. That is, it is possible to suppress ghost light reflected by the display device 40.

As a derivative example of the fourth exemplary embodiment, the first semi-transmissive reflective surface 21 may serve as the polarization beam splitter 21P. Especially in a case where the polarization beam splitter 21P is formed in a wire grid shape, part of linearly polarized light vibrating in the direction parallel to the paper is reflected by the polarization beam splitter 21P, whereby light that is reflected by the display device 40 is suppressed from returning to the polarization beam splitter 21P, and generation of unnecessary light can be suppressed.

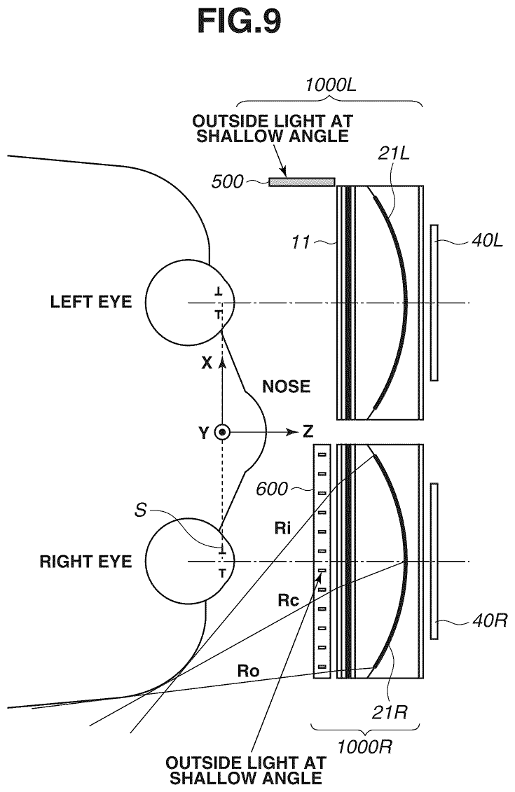

FIG. 9 is a diagram illustrating a configuration of reducing ghost light due to outside light incident on the observation optical system 1000 from a direction having a large angle with respect to the optical axis, that is, outside light at a shallow angle. A light-shielding wall 500 is a louver device in which a plurality of reed-shaped light-shielding portions is arranged. The configurations according to the first to third exemplary embodiments suppress ghost light due to outside light that is incident on the observation optical system 1000 from a direction that is approximately parallel to the optical axis, and can thereby reduce a thickness of the light-shielding wall 500 and a thickness of the light-shielding portions in a louver device 600 in the Z-axis direction. As a result, it is possible to suppress ghost light due to outside light at a shallow angle without causing feeling of inconvenience due to the arrangement of the light-shielding wall 500 and the louver device 600.

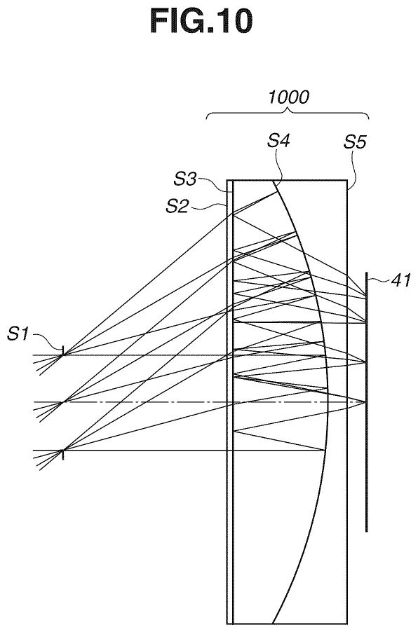

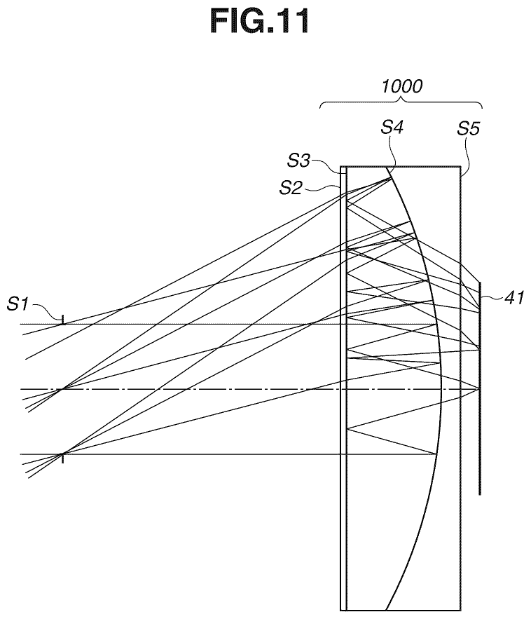

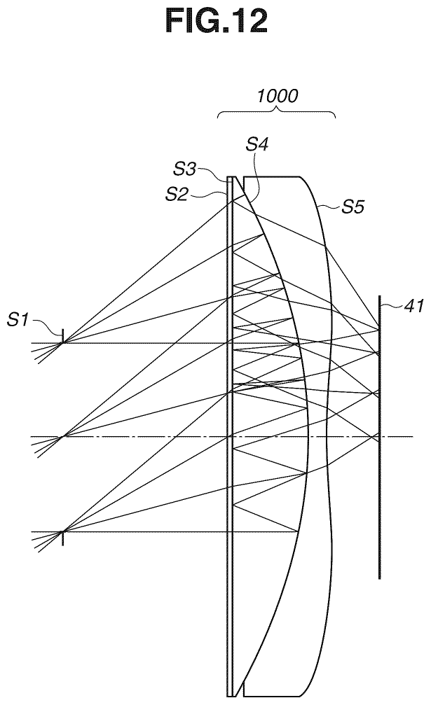

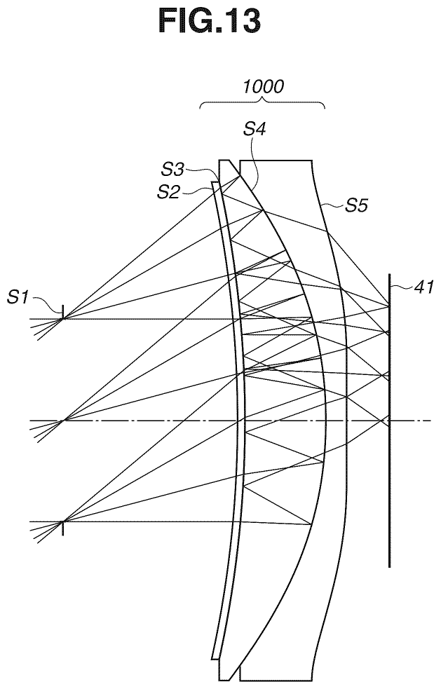

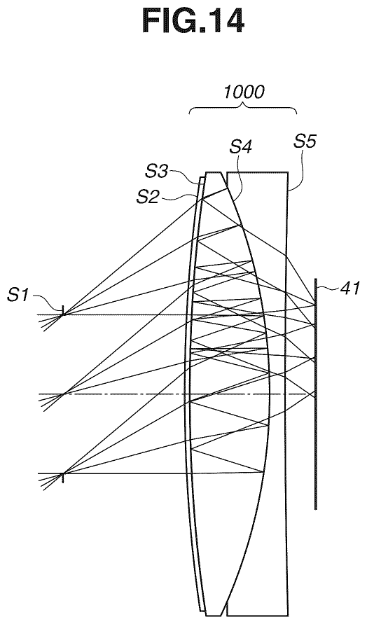

Numerical Examples 1 to 5 are now described. FIGS. 10 to 14 are optical path diagrams corresponding to Numerical Examples 1 to 5, respectively. Numerical Examples 1 to 5 indicate specific surface data of any of the first to fourth exemplary embodiments. The second semi-transmissive reflective surface 22, the first λ/4 plate 31, the second λ/4 plate 32, and the linear polarization plate 11 in the first to fourth exemplary embodiments are regarded as one flat plate in Numerical Examples 1 to 5.

In surface data of each Numerical Example, r represents a curvature radius of each optical surface, and d (mm) represents an on-axis interval (a distance on the optical axis) between an m-th surface and an (m+1)-th surface. A surface number 1 represents the position of the exit pupil S, and m represents a surface number counted from the exit pupil S side. In addition, nd represents a refractive index of each optical member with respect to a d-line. A number after S in FIGS. 10 to 14 corresponds to a surface number m in each Numerical Example.

When the X-axis is an optical axis direction, an H-axis is a direction perpendicular to the optical axis, a traveling direction of light is a positive direction, R represents a paraxial curvature radius, and each of A, B, C, and D represents an aspheric surface coefficient, an aspheric shape is expressed by X=(H²/R)/[1+{1−(H/R)²}^{1/2}]+A×h⁴+B×h⁶+C×h⁸+D×h¹⁰. * represents a surface having an aspheric shape. [E-x]represents 10^{-x}.

### Numerical Example 1

Unit: mm

| Number | | r | d | nd | vd |
|---|---|---|---|---|---|
| 1 | ∞ | 17.0 | 1.5163 | 64.1 | |
| 2 | ∞ | 1.0 | 1.5163 | 64.1 | |
| 3 | ∞ | 10.0 | | | |
| 4 | −50.000 | | 2.0 | 1.5163 | 64.1 |
| 5 | ∞ | 2.026 | | | |

| | | |
|---|---|---|
| Display surface | ∞ | 0 |

### Numerical Example 2

Unit: mm

| Number | | r | d | nd | vd |
|---|---|---|---|---|---|
| 1 | ∞ | 29.0 | | | |
| 2 | ∞ | 1.0 | 1.5163 | 64.1 | |
| 3 | ∞ | 10.0 | 1.5163 | 64.1 | |
| 4* | −50.000 | | 2.0 | 1.5163 | 64.1 |
| 5 | ∞ | 2.285 | | | |

| | | |
|---|---|---|
| Display surface | ∞ | 0 |

| | | | | |
|---|---|---|---|---|
| Fourth surface | A = 2.376E−06 | B = −8.480E−09 | C = 1.367E−11 | D = −6.993E−15 |

### Numerical Example 3

Unit: mm

| Number | | r | d | nd | vd |
|---|---|---|---|---|---|
| 1 | ∞ | 17.0 | | | |
| 2 | ∞ | 1.0 | 1.5163 | | |
| 3 | ∞ | 8.0 | 1.5446 | 64.1 | |
| 4* | −52.338 | | 2.0 | 56.2 | |
| 5* | 69.472 | 5.585 | | 1.6418 | 22.5 |

| | | |
|---|---|---|
| Display surface | ∞ | 0 |

| | | | | |
|---|---|---|---|---|
| Fourth surface | A = −5.3524E−07 | B = −3.1573E−10 | C = 1.9983E−12 | D = −6.6843E−17 |
| Fifth surface | A = 3.1426E−05 | B = 2.5264−08 | C = 2.634E−11 | D = −4.0278E−14 |

### Numerical Example 4

Unit: mm

| Number | | r | d | nd | vd |
|---|---|---|---|---|---|
| 1 | ∞ | 17.0 | | | |

| | | | | |
|---|---|---|---|---|
| 2 | −94.522 | 1.0 | 1.5163 | 64.1 |
| 3* | −94.522 | 8.0 | 1.5446 | 56.2 |
| 4* | −37.697 | 2.0 | 1.6418 | 22.5 |
| 5* | −848.438 | 4.1875 | | |

| | | |
|---|---|---|
| Display surface | ∞ | 0 |

| | | | | |
|---|---|---|---|---|
| Third surface | A = 1.3125E−06 | B = 3.7125E−10 | C = 2.5851E−13 | D = −3.4224E−16 |
| Fourth surface | A = −3.6185E−08 | B = −1.7627E−09 | C = 5.4487E−12 | D = −5.8886E−16 |
| Fifth surface | A = −2.1211E−05 | B = 1.5352E−08 | C = 2.2357E−11 | D = −2.0642E−14 |

### Numerical Example 5

Unit: mm

| Number | | r | d | nd | vd |
|---|---|---|---|---|---|
| 1 | ∞ | 15.0 | | | |

| | | | | |
|---|---|---|---|---|
| 2 | 200.000 | 1.0 | 1.5163 | 64.1 |
| 3 | 200.000 | 10.0 | 1.5446 | 56.2 |
| 4* | −67.109 | 2.0 | 1.6418 | 22.5 |
| 5 | 1082.122 | 3.7612 | | |

| | |
|---|---|
| Display surface | ∞ |

| | | | | |
|---|---|---|---|---|
| Fourth surface | A = −6.7130E−07 | B = 1.7585E−09 | C = 2.0854E−12 | D −1.4048E−15 |

The following table indicates various values according to the exemplary embodiments.

TABLE 1

| | Numerical | Numerical | Numerical | Numerical | Numerical |
|---|---|---|---|---|---|
| | Example 1 | Example 2 | Example 3 | Example 4 | Example 5 |
| LaA | 24.254 | 36.254 | 22.839 | 22.839 | 22.134 |
| \|fA\| | 16.487 | 16.487 | 16.942 | 12.203 | 21.724 |
| f | 16.487 | 16.487 | 18.061 | 17.280 | 17.341 |
| R | −50.000 | −50.000 | −52.338 | −37.697 | −67.109 |
| LaA/ | 1.471 | 2.199 | 1.348 | 1.872 | 1.019 |
| \|fA\| | | | | | |
| fA/f | 1.000 | 1.000 | 0.938 | 0.706 | 1.253 |
| R/f | −3.033 | −3.033 | −2.898 | −2.182 | −3.870 |

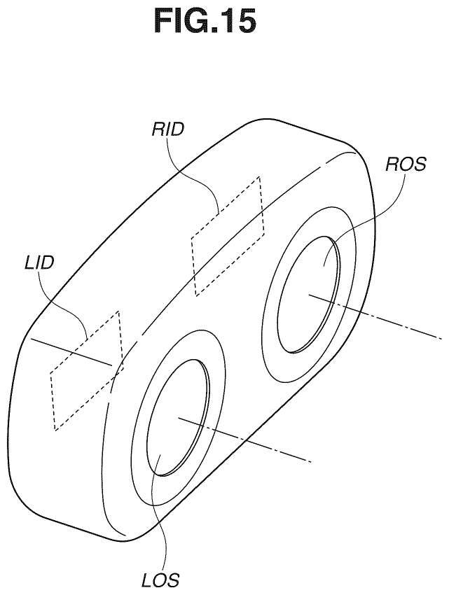

FIG. 15 is a view illustrating a head mounted display (HMD) as an image display apparatus using the observation optical system 1000 according to each of the first to fourth exemplary embodiments. The HMD is mounted on the head of the observer with a mounting gear, which is not illustrated.

The HMD includes a right-eye image display device RID, a left-eye image display device LID, a right-eye observation optical system ROS that guides display light from the right-eye image display device RID to the right eye of the observer, and a left-eye observation optical system LOS that guides display light from the left-eye image display device LID to the left eye of the observer.

With use of the observation optical system 1000 described in the first to fourth exemplary embodiments as the right-eye observation optical system ROS and the left-eye observation optical system LOS, it is possible to implement an HMD that has a wide view angle and a small size but is still advantageous in reduction of ghost light due to outside light.

While the description has been given of the exemplary embodiments and the examples, the present invention is not limited to these exemplary embodiments and examples, and these exemplary embodiments and examples can be combined, modified, and changed in various manners within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-084771, filed May 23, 2023, which is hereby incorporated by reference herein in its entirety.

What is claimed is:

1. An observation optical system configured to guide light from a display device configured to display an image to an observer, the observation optical system including a lens having a display-side surface and an observation-side surface with different curvature radii, and comprising:
a first semi-transmissive reflective surface;
a first λ/4 plate;
a second semi-transmissive reflective surface;
a second λ/4 plate; and
a linear polarization plate,
wherein the first semi-transmissive reflective surface, the first λ/4 plate, the second semi-transmissive reflective surface, the second λ/4 plate, and the linear polarization plate are sequentially arranged from a display side to an observation side, and
wherein, when, out of the first semi-transmissive reflective surface and the second semi-transmissive reflective surface, a reflection surface having a smaller absolute value of a focal length is a reflection surface A, a focal length of the reflection surface A is fA, and an air conversion distance on an optical axis from a position of an exit pupil to the reflection surface A is LaA, the following inequality is satisfied:
$$1.0 < LaA / \vert fA \vert < 3. .$$

2. The observation optical system according to claim 1, wherein, when a focal length of the observation optical system is f, the following inequality is satisfied:
$$0.60 < \vert fA \vert / f < 1.50 .$$

3. The observation optical system according to claim 1, wherein each of the first semi-transmissive reflective surface and the second semi-transmissive reflective surface is a half mirror.

4. The observation optical system according to claim 1,
wherein the first semi-transmissive reflective surface is a polarization beam splitter, and
wherein the second semi-transmissive reflective surface is a half mirror.

5. The observation optical system according to claim 1, wherein the reflection surface A is a concave surface that is concave toward the observation side.

6. The observation optical system according to claim 1, wherein the observation optical system includes a shielding member arranged closest to the observation side.

7. The observation optical system according to claim 6, wherein the shielding member has a reed shape and is a louver device arranged in a direction perpendicular to the optical axis.

8. The observation optical system according to claim 1,
wherein first polarized light is incident from the display side on the first semi-transmissive reflective surface,
wherein a polarization direction of first polarized light and a polarization direction of light passing through the polarization plate are parallel to each other, and
wherein a direction of a slow axis of the first λ/4 plate and a direction of a slow axis of the second λ/4 plate are parallel to each other.

9. The observation optical system according to claim 1,
wherein first polarized light is incident from the display side on the first semi-transmissive reflective surface,
wherein a polarization direction of first polarized light and a polarization direction of light passing through the polarization plate are perpendicular to each other, and
wherein a direction of a slow axis of the first λ/4 plate and a direction of a slow axis of the second λ/4 plate are perpendicular to each other.

10. The observation optical system according to claim 1, wherein light from the display device sequentially passes through, from the display side, the first semi-transmissive reflective surface and the first λ/4 plate, is reflected by the second semi-transmissive reflective surface, passes through the first λ/4 plate, is reflected by the first semi-transmissive reflective surface, and passes through the first λ/4 plate, the second semi-transmissive reflective surface, the first semi-transmissive reflective surface, the second λ/4 plate, and the linear polarization plate.

11. The observation optical system according to claim 1, wherein, when an absolute value of an angle of outside light incident from the observation side on the observation optical system is @, the following inequality is satisfied:
0°<@<45°.

12. The observation optical system according to claim 1, wherein, when a focal length of the observation optical system is f and a curvature radius of the reflection surface A is R, the following inequality is satisfied:
$$- 6.0 < R / f < 1. .$$

13. An image display apparatus comprising:
a display device configured to display an image; and
an observation optical system configured to guide light from the display device to an observer and including a lens having a display-side surface and an observation-side surface with different curvature radii,
the observation optical system including:
a first semi-transmissive reflective surface;
a first λ/4 plate;
a second semi-transmissive reflective surface;
a second λ/4 plate; and
a polarization plate,
wherein the first semi-transmissive reflective surface, the first λ/4 plate, the second semi-transmissive reflective surface, the second λ/4 plate, and the polarization plate are sequentially arranged from a display side to an observation side,
wherein, when, out of the first semi-transmissive reflective surface and the second semi-transmissive reflective surface, a reflection surface having a smaller absolute value of a focal length is a reflection surface A, a focal length of the reflection surface A is fA, and an air conversion distance on an axis from a position of an exit pupil to the reflection surface A is LaA, the following inequality is satisfied:
$$1.0 < LaA / \vert fA \vert < 3. .$$
